(19) United States
(12) Patent Application Publication
(10) Pub. No.: US 2007/0258271 A1
(43) Pub. Date: Nov. 8, 2007

(54) Multi-MHz power converter

(76) Inventor: Ivan Meszlenyi, Calgary (CA)

Correspondence Address: Ivan Meszlenyi, 3404 Richmond Rd. SW, Calgary, AB, T3E 4N6, CA

(21) Appl. No.: 11/787,961

(22) Filed: Apr. 19, 2007

(30) Foreign Application Priority Data
May 2, 2006 (CA) 2548891

(51) Int. Cl. H02M 3/335

(52) U.S. Cl. 363/16

(57) ABSTRACT

The present invention is a multi-MHz line converter providing a zero voltage, zero current converter under all line and load conditions limiting fixed frequency. Having very low noise generation due to its zero voltage, zero current nature, the converter offers a very low cost alternative for off-line low power converters.

### BACKGROUND OF THE INVENTION

1. Field of the Invention

The present invention generally relates to DC to DC converters and particularly those operating at very high frequency utilizing zero voltage and zero current switching. More specifically, the present invention relates to those DC to DC converters that have very large variation in input voltage such as universal input converters.

2. Description of the Prior Art

Topologies utilizing a transformer coupled high side N-channel drive are typically unnecessarily complex. The transformer provides isolation, a capacitively coupled rectifier restores the DC level, and the output waveform will have a reference voltage near zero.

The power processing of the prior art requires three switches where the third switch is used as a synchronous rectifier. In many low power and higher than 5V applications the third switch is not desirable. However, when attempting to eliminate this third switch by replacing it with a passive rectifier in the prior art, the leakage inductance of the transformer and reverse rectifier capacitance in the power train will cause excessive ringing, lowering efficiency and introducing high levels of RF radiation.

### SUMMARY OF THE INVENTION

The present invention provides a low cost and highly efficient power converter which has low noise generation due to its zero voltage and zero current switching while maintaining high power density.

Further, the present invention is practical for multi-MHz operation thus providing a superior alternative to the prior art.

### BRIEF DESCRIPTION OF DRAWINGS

FIG. 1 is a schematic diagram of a typical implementation of the prior art.

FIG. 2 is an illustration of the voltage and current waveforms essential to the understanding of the prior art.

FIG. 3 is schematic diagram of the preferred embodiment of the present invention.

FIG. 4 is an illustration of the voltage and current waveforms essential to the understanding of the present invention.

### DETAILED DESCRIPTION OF THE PREFERRED EMBODIMENT

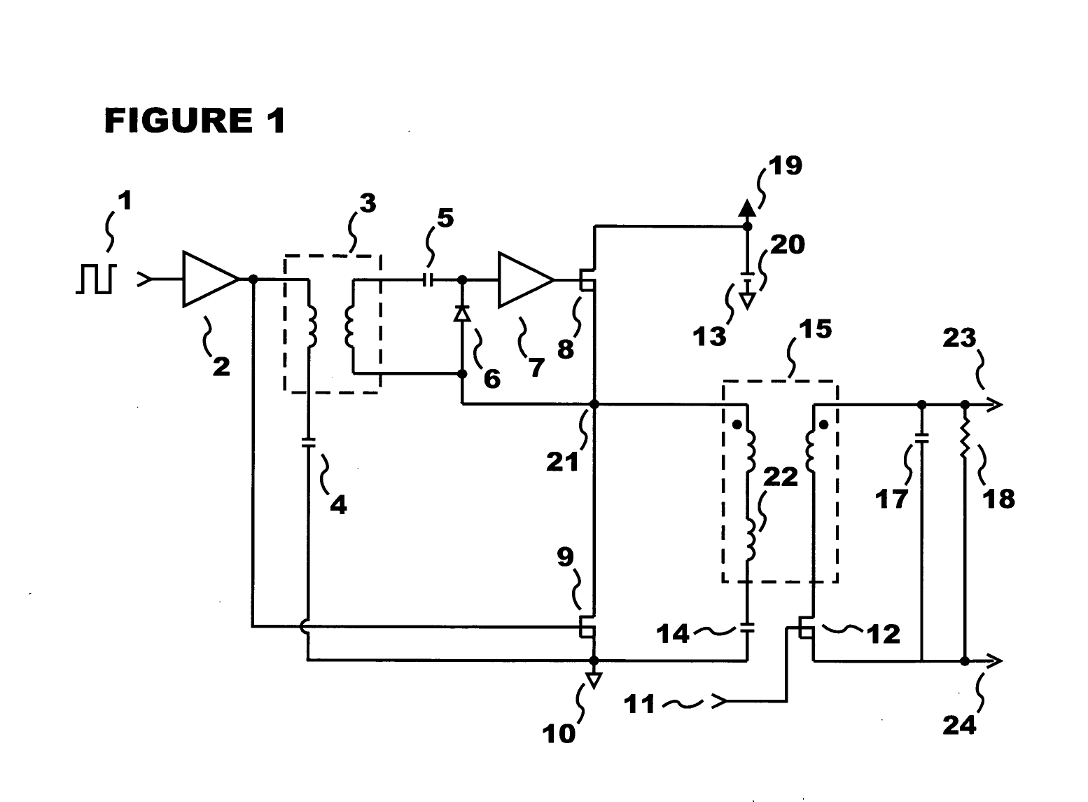

In order to better understand the present invention, a prior art converter will be described with reference to FIG. 1. A PWM signal 1 is connected to the input of a buffer 2, the output of said buffer 2 is connected to the gate terminal of lower MOSFET 9. Lower MOSFET 9 is additionally provided with source and drain terminals, as is upper MOSFET 8. The output of said buffer 2 is additionally connected to a terminal of the primary winding of drive transformer 3. The other terminal of said primary winding is connected to a capacitive element 4. The other side of said capacitive element 4 is connected to negative terminal 10. A terminal of the secondary winding of said drive transformer 3 is connected to second capacitive element 5, the other side of which is connected to the input of second buffer 7. The other terminal of the secondary winding of said drive transformer 3 is connected to the junction 21 of source terminal of upper MOSFET 8 and drain terminal of lower MOSFET 9. A rectifier element 6 has a cathode connected to the junction of said second capacitive element 5 and the input of said second buffer 7. The anode of said rectifier element 6 is connected to said junction 21. The drain terminal of upper MOSFET 8 is connected to the positive terminal 19 of DC supply 13 and source terminal of lower MOSFET 9 is connected to the negative terminal 20 of a DC supply 13. Negative terminals 10 and 20 are the same point and are separated for the purposes of illustration.

A transformer 15 is provided with a primary and secondary winding and is illustrated with is inherent leakage inductance 22. The primary winding, in series with leakage inductance 22, of said transformer 15 is connected between said MOSFET junction 21 and one terminal of coupling capacitor 14. The other terminal of said coupling capacitor 14 is connected to said negative terminal 20. One terminal of the secondary winding of said transformer 15 provides the first output 23 of the converter and the other terminal of said secondary winding is connected to the drain terminal of a third MOSFET 12 driven by PWM signal synchronized with input PWM signal 1 at MOSFET gate 11. The source terminal of said third MOSFET 12 provides the second output 24 of the converter. A capacitive element 17 and a load resistance 18 are connected across said first and second outputs.

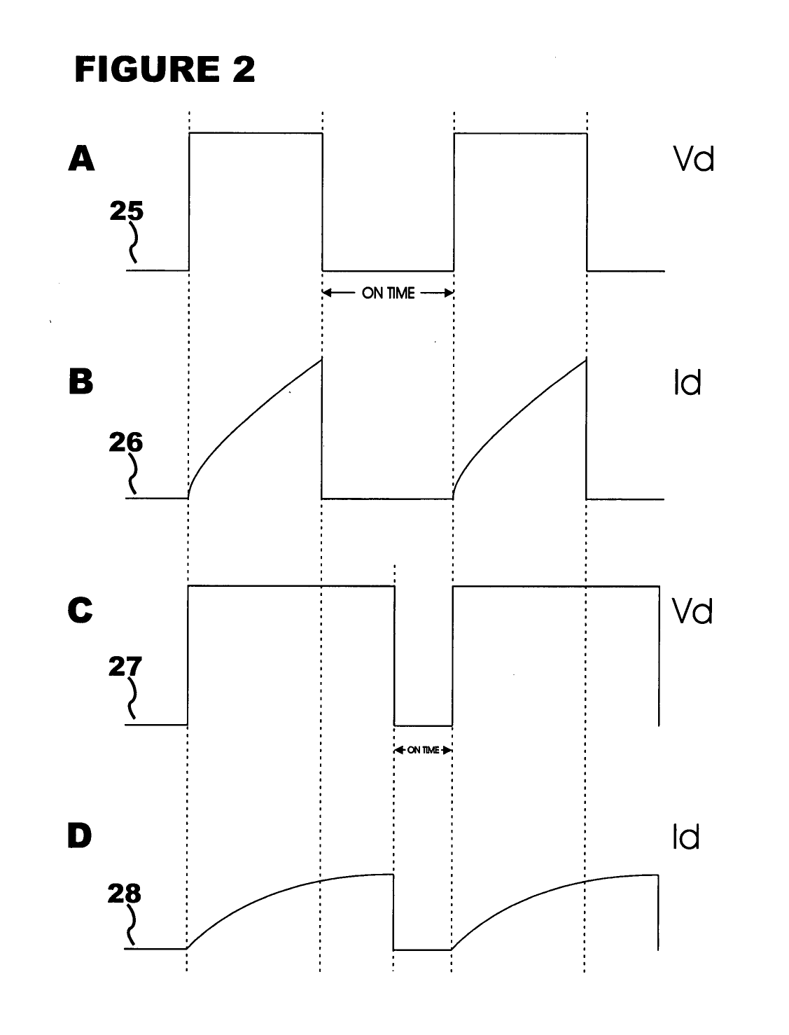

The operation of the prior art converter will be described with reference to FIGS. 1 and 2. The input PWM signal 1 is amplified by buffer 2 to drive lower MOSFET 9. The PWM signal 1 is also sent to second buffer 7 via drive transformer 3 restoring the DC level by the capacitively coupled rectifier 6 and driving upper MOSFET 8. The power amplified signal will appear at junction 21 of upper and lower MOSFETs 8 and 9.

The transformer 15 with said leakage inductance 22 in series with coupling capacitor 14 will produce a current waveform 26 on the secondary winding of said transformer 15 as in FIG. 2 during off time with the corresponding voltage waveform 25 appearing at junction 21 under low line full load conditions. Under high line full load conditions, a current waveform 28 will be produced on the secondary winding of said transformer 15 with the corresponding voltage waveform 27 appearing at junction 21. A third MOSFET 12 is required to be used in a synchronous rectifier configuration on the output of this converter.

In accordance with an embodiment of the present invention, a multi-MHz converter is generally provided with an input PWM signal, an inverter element, an upper and lower delay, an upper and lower buffer, a pair of MOSFETs, a transformer with leakage, a resonant capacitor, and a first and second output.

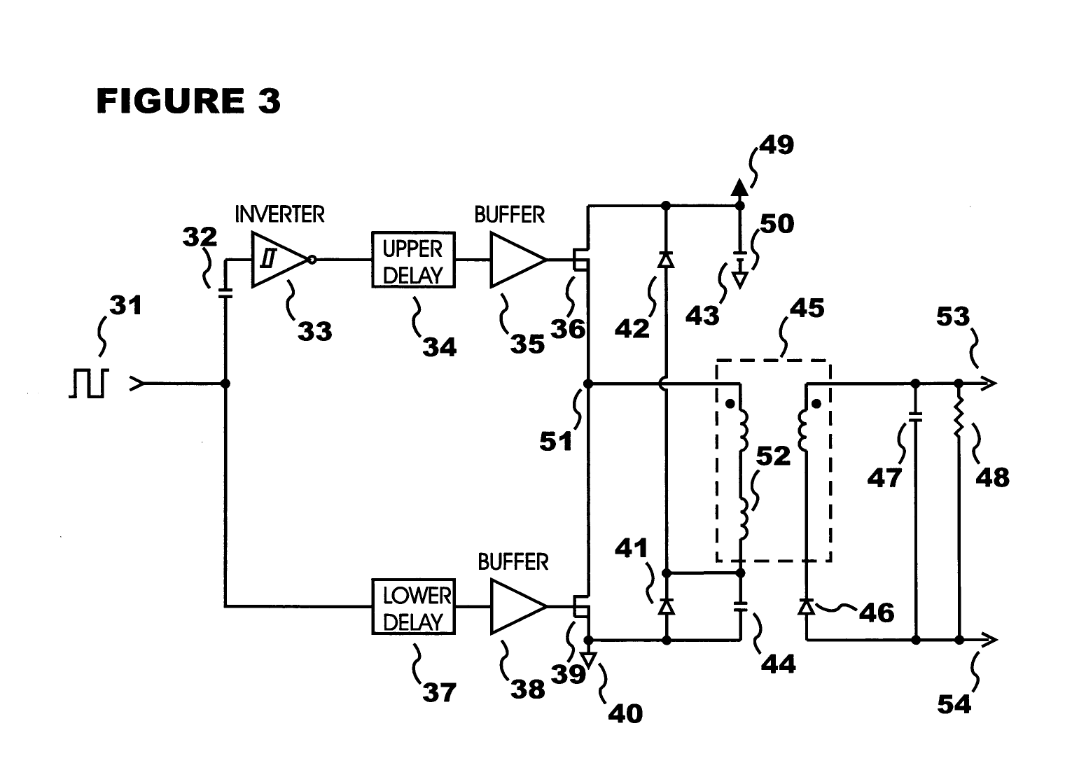

In order to better understand the embodiment of the present invention, a multi-MHz converter will be described with reference to FIG. 3. A PWM signal 31 is connected to a level shifter capacitor 32 and the input of a lower delay 37, the other side of said level shifter capacitor 32 is connected to the input of a Schmitt inverter 33. The output of said Schmitt inverter 33 is connected to the input of an upper delay 34. The output of said upper delay 34 is connected to the input of an upper buffer 35 and the output of said lower delay 37 is connected to the input of a lower buffer 38. The output of said upper and lower buffers 35 and 38 are connected to the gate terminals of upper and lower MOSFETs 36 and 39 respectively. Said MOSFETs 36 and 39 are each additionally provided with source and drain terminals. The source terminal of upper MOSFET 36 is connected to the drain terminal of lower MOSFET 39 at junction 51. The drain terminal of upper MOSFET 36 is connected to the positive terminal 49 of DC supply 43 and source terminal of lower MOSFET 39 is connected to the negative terminal 50 of a DC supply 43. Negative terminals 40 and 50 are the same point and are separated for the purposes of illustration. A first diode element 42, has a cathode connected to said positive terminal 49 and an anode connected to the cathode of a second diode element 41. The junction of said diodes 41 and 42 is connected to a terminal of resonant capacitor 44. The anode of said second diode 41 is connected to said negative terminal 40.

A transformer 45 is provided with a primary and secondary winding and is illustrated with its inherent leakage inductance 52. The primary winding, in series with leakage inductance 52, of said transformer 45 is connected between said MOSFET junction 51 and one terminal of a resonant capacitor 44. The other terminal of said resonant capacitor 44 is connected to said negative terminal 40. One terminal of the secondary winding of said transformer 45 provides the first output 53 of the converter and the other terminal of said secondary winding is connected to the cathode of a rectifier 46. The anode of said rectifier 46 provides the second output 54 of the converter. A capacitive element 47 and a load resistance 48 are connected across said first and second outputs.

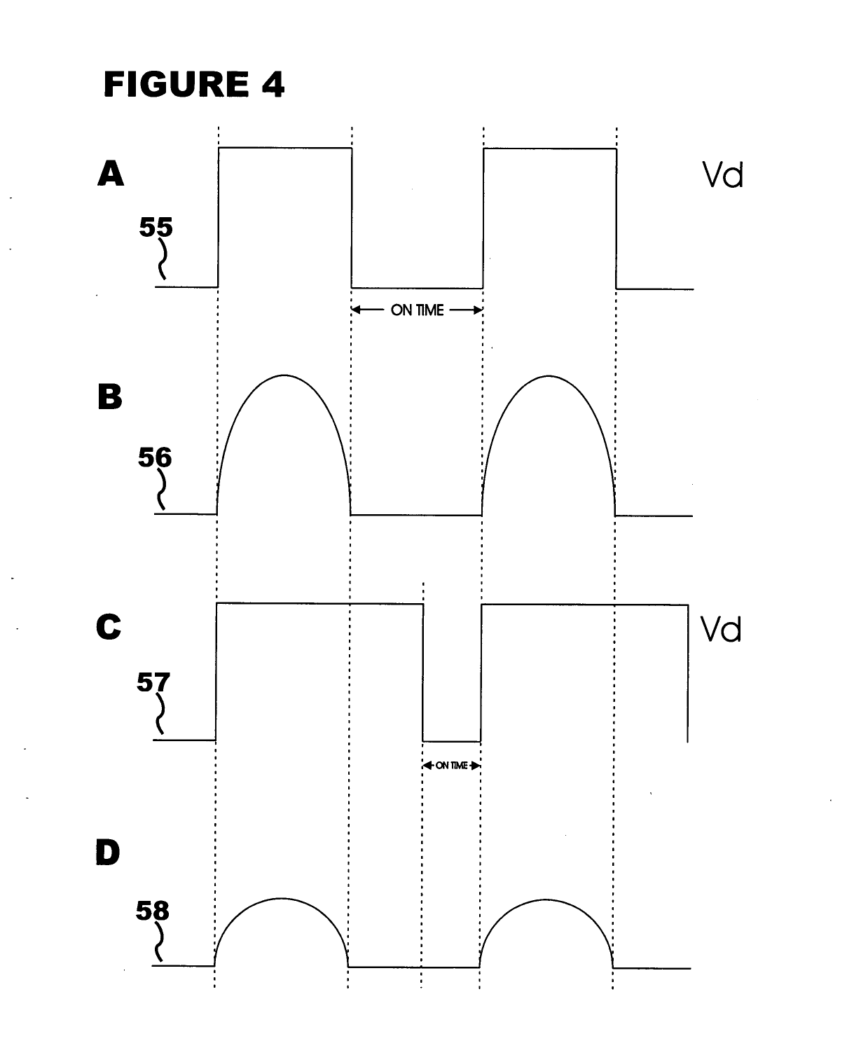

The operation of the present invention will now be described with reference to FIGS. 3 and 4. The input PWM signal 31 will be amplified by lower buffer 38 to drive lower MOSFET 39. A lower delay 37 is inserted between the lower buffer 38 and the PWM signal 31 so that the rising edge of the gate drive signal for lower MOSFET 39 will be delayed.

The PWM signal 31 is also sent to upper buffer 35 via upper delay 34 to have the rising edge of the gate drive signal for the upper MOSFET 36 delayed.

The PWM signal 31 is capacitively coupled to Schmitt inverter 33 so that when switching takes place at the junction 51 of upper and lower MOSFETs 36 and 39, the dV/dt induced current into the input of the Schmitt inverter 33 is in the same phase as the current induced by input PWM signal 31. The power amplified signal will appear at the junction 51 of upper and lower MOSFETs 36 and 39.

The transformer 45 with said leakage inductance 52 in series with resonant capacitor 44 will produce a half sinusoidal current waveform 56 on the secondary winding of said transformer 45 as in FIG. 4 during off time with the corresponding voltage waveform 55 appearing at junction 51 under low line full load conditions. Under high line full load conditions, a current waveform 58 will be produced on the secondary winding of said transformer 45 with the corresponding voltage waveform 57 appearing at junction 51. The current in the resonant tank formed by leakage inductance 52 and the resonant capacitor 44 will be essentially zero provided that the resonance is designed for the worst case (i.e. low line full load).

The sum of the reflected load current and the current through the magnetizing inductance of transformer 45 is used to facilitate the switching during dead zone.

I claim:

1. A multi-MHz power converter comprising:
(a) an input PWM signal fed into the junction of a level shifter capacitor and the input of a lower delay network;
(b) the other side of said capacitive level shifter connected to an inverter input;
(c) the output of said inverter connected to the input of an upper delay network;
(d) the output of said upper delay network connected to a buffer;
(e) the output of said buffer driving the gate of an upper MOSFET;
(f) the drain terminal of said upper MOSFET connected to the positive terminal of a DC source;
(g) a junction of the source terminal of said upper MOSFET and the drain terminal of a lower MOSFET;
(h) the source terminal of said lower MOSFET connected to the negative terminal of said DC source;
(i) the gate terminal of said lower MOSFET connected to the output of a lower buffer;
(j) the input terminal of said lower buffer connected to the output of said lower delay network;
(k) the junction of said upper and lower MOSFETs connected to a power transformer;
(l) said power transformer having a primary and secondary winding and a leakage inductance;
(m) a resonant capacitor in series with the primary winding and leakage inductance of said power transformer;
(n) upper and lower clamping diodes in series connected across said DC source with cathodes towards the positive terminal of same;
(o) said lower clamping diode in parallel with said resonant capacitor.

2. A multi-MHz power converter as in claim 1, wherein said level shifter capacitor has significantly large value to overcome the input capacitance of said inverter.

3. A multi-MHz power converter as in claim 1, wherein said inverter had sufficiently large hysteresis to overcome false triggering.

4. A multi-MHz power converter as in claim 3, wherein said inverter, or an odd multiple thereof, ensures that said input PWM signal is 180 degrees out of phase with the output of said junction of upper and lower MOSFETs reducing the effect of current inducing stray capacitances at the input of the inverter.

5. A multi-MHz power converter as in claim 1, wherein said lower delay network sufficiently delays the signal rising edge to avoid cross conduction.

6. A multi-MHz power converter as in claim 1, wherein said upper delay network sufficiently delays the signal driving said upper MOSFET.

7. A multi-MHz power converter as in claim 1, wherein said transformer has a predetermined magnetizing inductance of sufficient value to ensure zero voltage switching under all line and load conditions and a predetermined leakage inductance.

8. A multi-MHz power converter as in claim 1, wherein said resonant capacitor resonates with said leakage inductance such that under all line and load conditions the current returns to zero thereby ensuring a high average to RMS current ratio while preserving zero current switching.

9. A multi-MHz power converter as in claim 1, wherein said clamping diodes serve to clamp voltage across said resonant capacitor limiting the maximum output current.
